(19) United States
(12) Patent Application Publication
(10) Pub. No.: US 2010/0166268 A1
(43) Pub. Date: Jul. 1, 2010

(54) STORAGE SYSTEM FOR STORING THE SAMPLING DATA OF PATHOLOGICAL SECTION AND METHOD THEREOF

(75) Inventor: WILLIAM PAN, Taipei City (TW)

Correspondence Address: ROSENBERG, KLEIN & LEE, 3458 ELLICOTT CENTER DRIVE-SUITE 101, ELLICOTT CITY, MD, 21043, US

(73) Assignee: EBM TECHNOLOGIES INCORPORATED, Taipei City (TW)

(21) Appl. No.: 12/346,085

(22) Filed: Dec. 30, 2008

(51) Int. Cl. G06K 9/00

(52) U.S. Cl. 382/128

(57) ABSTRACT

A storage system and method thereof for storing the sampling data of a pathological section, the steps of the method includes taking variously magnified tissue images from the pathological section; moreover, comparing respectively the variously magnified tissue images with an original image with matching magnification so as to generate the coordinates of the variously magnified tissue images corresponded to the original symptom image; furthermore, integrating the variously magnified tissue images and its corresponded coordinates into a sampling data, then storing the sampling data.

### BACKGROUND OF THE INVENTION

1. Field of the Invention

The present invention relates to a storage system for storing sampling data of pathological section and method thereof; in particular, to a storage system and method thereof for improving medical data management and storage.

2. Description of Related Art

As computer technologies advance, digitalization of medical information and management of high efficiency thereof have now become important and necessary trends. Conventionally, medical data of patients are displayed on physical documents by doctors (e.g. medical history data in the form of papers and file folders, X-ray films and the like), which occupy large storage space and consume huge amount of resources such as manpower, capital investment for archiving processes. Presently, it is possible to use computer technologies to perform systematic management on medical data by means of database, in conjunction with data transfer over computer network, allowing more effective transition and utilization of the entire medical data, which provides significant progress and efficiency on service quality of patient medication as well as medical affair management for hospitals.

Besides, demand for medical images on clinical diagnosis applications also increases. Many medical instruments offer digitalized medical data, but still large portion therein are not stored in standardized digital formats. However if a standardized digital formats can be agreed upon, the exchange of digital medical data in standardized formats between different hospital information systems becomes possible, which facilitates deployment of medical resources and enhancement of medical operation efficiency. DICOM (Digital Imaging and Communication in Medicine) standard is one commonly used standard for medical image exchange nowadays, which provides definitions concerning waveform information objects, allowing digital medical images from various medical units to have a common imaging standard for mutual exchange and transfer.

At the same time, traditional microscopes are still very widely used in medical academies, schools, nursery, and caring facilities, instead of electronic microscopes, as tools for micro observations. Physicians and nursery personnel need to request patients for body tissue sampling (i.e. biopsy), making tissue sections (sometimes also referred to as pathological sections) then using optical microscopes for micro observation and verification.

However, after enlargement of tissue image, in case of lacking relevant supportive information such as relative coordinate, enlargement multiplicities and so on, it becomes meaningless graphics, thus impossible to revert to original state as understandable tissue image information.

### SUMMARY OF THE INVENTION

In view of the aforementioned issues, the present invention provides a storage system for sampling data of pathological section and method thereof, which takes variously magnified tissue images from the pathological section, compares respectively each of the variously magnified tissue images with the original image enlarged to the same degree of magnification (the original symptom image enlarged with the same magnification as the tissue image currently being compared, a.k.a. original image with matching magnification), and generates the coordinates of the variously magnified tissue images corresponding to the original symptom image, then integrates and stores the variously magnified tissue images and their corresponding coordinates into a sampling data (i.e. the sampling data of pathological sections), which allows physicians to explicitly appreciate the position of the magnified tissue images in the original symptom image when viewing the tissue images, facilitating fast biopsy analysis.

The storage method for sampling data of pathological section according to the present invention consists of taking an original symptom image from a pathological section; then selecting a region of interest (ROI) on the original symptom image, and enlarging the selected ROI so as to generate a magnified tissue image. Next, it compares the magnified tissue image with the original symptom image with matching magnification, and compares the original symptom image with matching magnification against the original symptom image, so as to acquire the corresponding image coordinates of the magnified tissue image in the original symptom image. Subsequently, it integrates the magnified tissue image and its corresponding image coordinates into a sampling data, and stores the generated sampling data for doctors' further references.

Based on the above-mentioned descriptions, the storage system for sampling data of pathological section according to the present invention comprises an imaging optical microscope (referred as imaging microscope hereunder), a comparing device, an integrating device and a storage device. Herein, the imaging microscope takes an original symptom image from a pathological section, and enlarges a specific ROI on the original symptom image, thus generating a magnified tissue image. The comparing device is coupled to the imaging optical microscope for comparing the magnified tissue image against the original symptom image with matching magnification, so as to generate the corresponding image coordinate of the magnified tissue image in the original symptom image. The integrating device is coupled to the comparing device for integrating the magnified tissue image and the generated image coordinate into a sampling data. The storage device is coupled to the integrating device for storing the sampling data.

In summary, the storage system for storing sampling data of pathological section and the storage method thereof according to the present invention compares variously magnified tissue images against the original symptom image with matching magnification to acquire the corresponding image coordinates of the variously magnified tissue image on the original symptom image, then integrates the variously magnified tissue image and the corresponding image coordinate into the sampling data. In this way, when physicians are viewing the magnified tissue images, they can explicitly appreciate the relative positions of variously magnified tissue images on the original symptom image through simple search operations, further providing rapid and correct biopsy analysis, thus improving medical treatment quality.

The summary illustrated supra and detailed descriptions set out infra are simply for illustrative purposes, which further describe the claimed scope of the present invention. Other objectives and advantages of the present invention will be explained in the following illustrations and appended diagrams.

### BRIEF DESCRIPTION OF THE DRAWINGS

FIG. 1 is a flowchart of the storage method for sampling data of pathological section according to the present invention;

FIG. 2 is a block diagram of the storage system for sampling data of pathological section according to the present invention;

FIG. 3 is a flowchart of a method according to the present invention; and

FIG. 4 is a flowchart of another method according to the present invention.

### DETAILED DESCRIPTION OF PREFERRED EMBODIMENTS

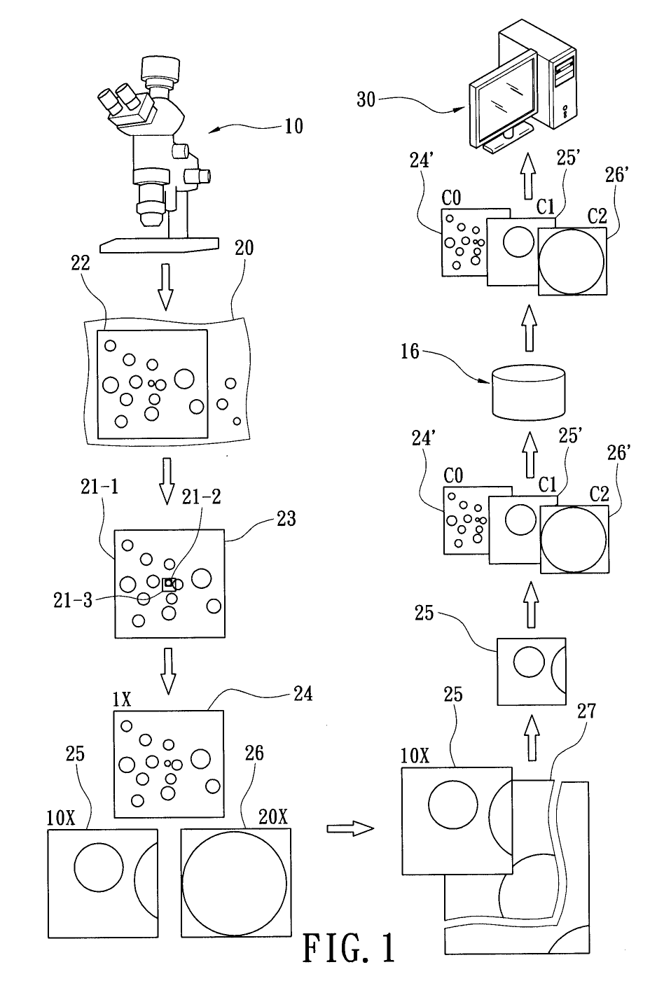

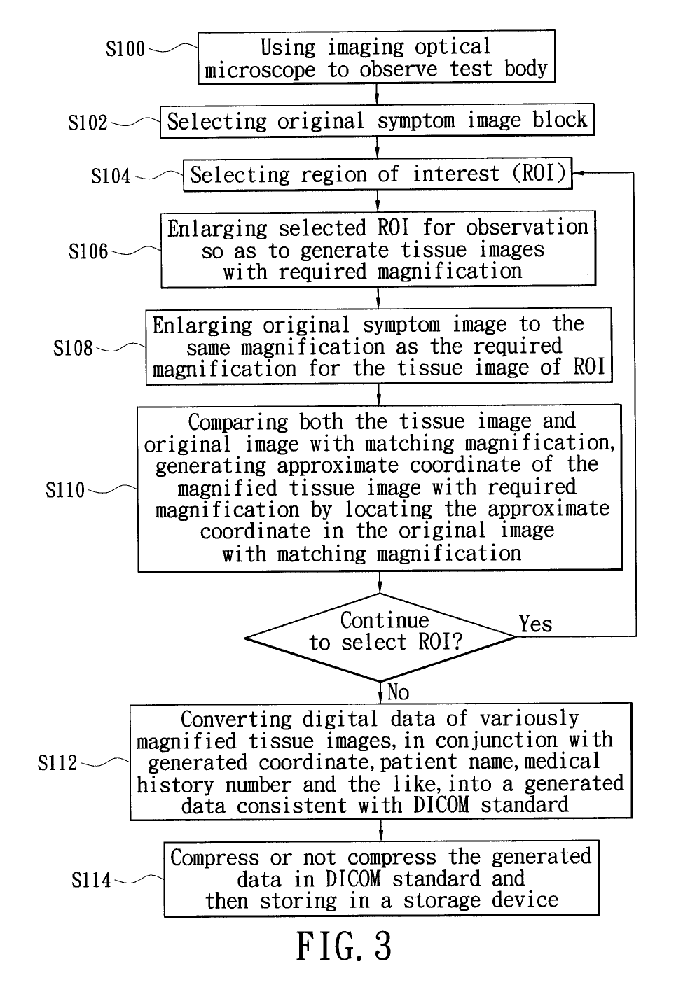

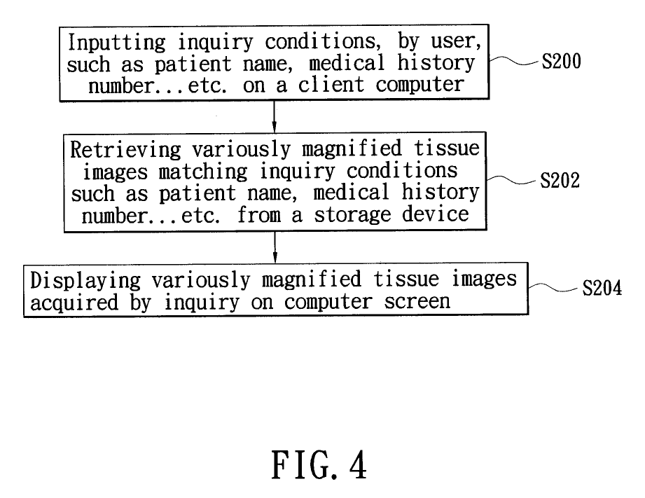

Refer now to FIG. 1 wherein a flowchart of the storage method for sampling data of pathological section (i.e. biopsy) according to the present invention is shown. Meanwhile, refer also to FIGS. 3 and 4, in which a flowchart of the method according to the present invention is respectively shown. First of all, select an imaging microscope 10, then place the pathological section 20 obtained from the body of a patient on the observation stage of the imaging microscope 10 (S100), wherein the pathological section 20 is a test section for microscope observation made from pathological tissue such as tissue section of human tissue blood, bacteria, or excrement. Then, select an observation region on the pathological section 20, and use the imaging microscope 10 to capture an image of the selected observation region in order to generate an original symptom image 23 (S102). Next, select a region of interest (ROI) 21-1 from the generated original symptom image 23 (S104), and then enlarge the region of interest (ROI) 21-1 based on required magnification, further obtaining a magnified tissue image 24 (S106). As such, FIG. 1 shows a 1× magnified tissue image 24.

Referring again to FIG. 1, subsequently, enlarge the original symptom image 23 into the original image 27 with matching magnification (which means, original image 27 has a 1× magnification when matched against original symptom image 24 [not shown in FIG. 1]; a 10× magnification when matched against 25 [shown in FIG. 1]; a 20× magnification when matched against 26 [not shown in FIG. 1]) according to above-described magnification. In other words, original image 27 with matching magnification currently has 1× magnification. Furthermore, it should be noted that “the original image with matching magnification” is the same as “the original symptom image with matching magnification”; therefore, once the original symptom image has been defined, an article “the” then can be used with “the original image with matching magnification” (i.e. claim 7). Thus herein the original symptom image 23 is enlarged for 1× into the original image 27 with matching magnification. Then, use software program to Z-way scan (e.g. scanning from left to right and from top to bottom) the acquired 1× magnified tissue image 24, comparing it with the original image 27 with matching magnification for further finding out the approximate coordinate C0 of the 1× magnified tissue image 24 in the original image 27 with matching magnification (S110), and setting this coordinate C0 as the corresponding image coordinate C0 of the 1× magnified tissue image 24 in the original symptom image 23.

Subsequently, the process performs again step S104, which selects another ROI 21-2 (requires 10× magnification) and ROI 21-3 (requires 20× magnification) on the original symptom image 23. Then, based on the required magnification, enlarge the selected ROI 21-2 and ROI 21-3, further generating the magnified tissue images 25 and 26 (S106). As such, FIG. 1 shows the 10× magnified tissue image 25 and 20× magnified tissue image 26.

Referring again to FIG. 1, next, according to the aforementioned 10× and 20× magnifications, enlarge the original symptom image 23 to respectively generate the original images 27 with respective matching magnifications (S108) (original image 27 has a 10× magnification when matched against original symptom image 25; has a 20× magnification when matched against original symptom image 26 [not shown in FIG. 1]). Then, similarly use software program to Z-way scan the acquired 10× magnified tissue image 25 and compare with the original image 27 with matching magnification (10× magnification of original symptom image 23) for further finding out the approximate coordinate C1 of the 10× magnified tissue image 25 in the original image 27 with matching magnification (S110), and setting this coordinate C1 as the corresponding image coordinate C1 of the 10× magnified tissue image 25 in the original symptom image 23. In the same way, use once more software program to Z-way scan the acquired 20× magnified tissue image 26 and compare with the original image 27 with matching magnification (20× magnification of original symptom image 23) for further finding out the approximate coordinate C2 of the 20× magnified tissue image 26 in the original image 27 with matching magnification (S110), and setting this coordinate C2 as the corresponding image coordinate C2 of the 20× tissue image 26 in the original symptom image 23.

In this way, through the above-mentioned processes, it is possible to generate variously magnified tissue images 24, 25, 26, which respectively correspond to the image coordinates C0, C1, C2 in the original symptom image 23.

Referring again to FIG. 1, after respectively comparing the 1× magnified tissue image 24, the 10× magnified tissue image 25 and the 20× magnified tissue image 26 with the original symptom image 23, it is possible to acquire the corresponding image coordinates C0, C1, C2 in the original symptom image 23. Next, convert each magnified tissue images 24′, 25′, 26′ having respective image coordinate C0, C1, C2, along with information such as patient name, gender, medical history number, image name, and magnification into a sampling data D1 in DICOM format (S112). Finally, based on the compression or non-compression requirement, store the sampling data D1 in DICOM format in a storage device 16 (S114) for physicians' reference.

Referring once again to FIG. 1, when a doctor needs to examine the sampling data D1 stored in the storage device 16, he/she only has to perform simple search condition input based on characters in the pathological section 20, including inquiry conditions like patient name, medical history number, . . . etc. in order to retrieve the sampling data D1 corresponding to the pathological section 20 from the storage device 16. After processes of conversion, decompression on the retrieved sampling data D1, it is possible to generate each magnified tissue images 24′, 25′, 26′ having respective image coordinate C0, C1, C2, along with information like patient name, gender, medical history number, image name, magnification and so on (S202). Doctors may use a terminal computer 30 to access each of the aforementioned magnified tissue images 24′, 25′, 26′ having respective image coordinate C0, C1, C2 and information such as patient name, gender, medical history number, image name and magnification, so as to clearly appreciate the relative positions of variously magnified tissue images 24, 25, 26 in the original symptom image 23, facilitating quick biopsy analysis and thus improving medical treatment quality. Meanwhile, physicians may also perform operations like editing, adjustment, browsing on various kind of aforementioned information.

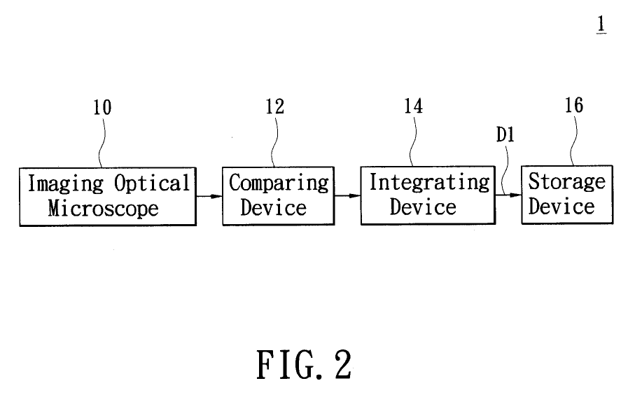

In conjunction with FIG. 1, refer now to FIG. 2. FIG. 2 shows a block diagram of the storage system for sampling data of pathological section according to the present invention. The depicted storage system 1 comprises an imaging optical microscope 10, a comparing device 12, an integrating device 14 and a storage device 16. Herein it uses the imaging optical microscope 10 to take an original symptom image 23 from the pathological section 20, and selects a ROI from the original symptom image 23 and enlarges the selected ROI to generate each magnified tissue images 24, 25, 26. The comparing device 12 is coupled to the imaging optical microscope 10, and the comparing device 12 uses the software program to Z-way scan in order to compare each magnified tissue images 24, 25, 26 against the original image 27 with matching magnification, in order to respectively finding out the approximate coordinate C0, C1, C2 of the magnified tissue images 24, 25, 26 in the original symptom image 23, and respectively setting the coordinate C0, C1, C2 as the corresponding image coordinate C0, C1, C2 of each magnified tissue images 24, 25, 26 in the original symptom image 23. The integrating device 14 is coupled to the comparing device 12, wherein the integrating device 14 individually integrates the generated magnified tissue images 24, 25, 26 with the image coordinate C0, C1, C2, in conjunction with information such as patient name, gender, medical history number, image name, and magnification, so as to convert all the information into a sampling data D1 in DICOM format. Then, based on the compression or non-compression requirement, it stores the sampling data D1 in a storage device 16 of the integrating device 14, wherein the storage device 16 is a database.

Refer again to FIG. 2, when a doctor needs to examine the sampling data D1 stored in the storage device 16, the doctor only has to perform simple search condition input based on characters in the pathological section 20 to retrieve the sampling data D1 corresponding to the pathological section 20 from the storage device 16. After processes of conversion, decompression on the retrieved sampling data D1, it is possible to generate the original symptom image 23, variously magnified tissue images 24, 25, 26 and respective image coordinate C0, C1, C2 of the pathological section 20, along with information like patient name, gender, medical history number, image name, magnification and so on, allowing doctors to explicitly appreciate the relative positions of variously magnified tissue images 24, 25, 26 in the original symptom image 23, facilitating quick biopsy analysis and thus improving medical treatment quality. At the same time, physicians may also perform operations like editing, adjustment, or browsing on various kind of aforementioned information.

In summary of the above-stated descriptions, the storage system for storing sampling data of pathological section and method thereof according to the present invention uses the comparison of variously magnified tissue images and the original image with matching magnification to acquire the corresponding image coordinate of variously magnified tissue image in the original symptom image, then respectively integrates the variously magnified tissue images and the corresponding image coordinate thereof into a sampling data. As such, when a doctor is viewing the tissue image, he/she may only need to perform simple search operations, and the computer system can be instructed to obtain the entire group of tissue images and coordinates thereof of the specific patient from the database, then, after reconstruction processes through computer program operations, each image and respective relevant position can be shown on a computer screen in an understandable way; furthermore, physicians may merely depend on each tissue images and respective relevant coordinate to manually create an understandable reference images without computer process, so as to facilitate quick diagnosis on patients and improve medical treatment quality accordingly.

The above-mentioned descriptions only illustrate the preferred embodiments of the present invention; however, the characteristics of the present invention are by no means limited thereto, and any changes or modifications that a skilled one in the related art can conveniently consider in the field of the present invention are all deemed to be encompassed by the scope of the present invention defined in the claims set out hereunder.

What is claimed is:

1. A storage method for sampling data of pathological section according to the present invention, comprising:
a. taking an original symptom image from a pathological section;
b. selecting a region of interest (ROI) on the original symptom image;
c. enlarging the selected ROI so as to generate a magnified tissue image;
d. comparing the magnified tissue image with the original symptom image with matching magnification, and then matches the original symptom image with matching magnification against the original symptom image, so as to acquire the corresponding image coordinates of the magnified tissue image in the original symptom image;
e. integrating the magnified tissue image and its corresponding image coordinates into a sampling data; and
f. storing the generated sampling data.

2. The storage method for sampling data of pathological section according to claim 1, wherein the pathological section is a pathological tissue section of human tissue or blood, bacteria, excrement, made as a test section for microscope observation.

3. The storage method for sampling data of pathological section according to claim 1, wherein, in step d, the magnified tissue image being Z-way scanned to be compared with the original image with matching magnification, and based on the comparison result, acquiring the corresponding image coordinate of the magnified tissue image in the original image with matching magnification.

4. The storage method for sampling data of pathological section according to claim 1, wherein, in step e, further integrating patient name, gender, medical history number, image name, and magnification as the sampling data.

5. The storage method for sampling data of pathological section according to claim 1, wherein, in step e, the sampling data is in DICOM standard format.

6. The storage method for sampling data of pathological section according to claim 1, wherein, in step a-c, an imaging microscope takes the original symptom image from the pathological section, and enlarges the region of interest (ROI) to generate the magnified tissue image.

7. A storage system for sampling data of pathological section according to the present invention, comprising:
an imaging microscope, which takes an original symptom image from a pathological section, and enlarges a specific ROI on the original symptom image, thus generating a magnified tissue image;
a comparing device, which is coupled to the imaging microscope for comparing the magnified tissue image with the original image with matching magnification, so as to generate the corresponding image coordinate of the magnified tissue image in the original symptom image;
an integrating device, which is coupled to the comparing device for integrating the magnified tissue image and the generated image coordinate into a sampling data; and
a storage device, which is coupled to the integrating device for storing the sampling data.

8. The storage system for sampling data of pathological section according to claim 7, wherein the comparing device compares the magnified tissue image with the original image with matching magnification in a Z-way scan fashion, and based on the comparison result, generates the corresponding image coordinate of the magnified tissue image in the original image with matching magnification.

9. The storage system for sampling data of pathological section according to claim 7, wherein the integrating device is a compression device, which compresses the magnified tissue image and the image coordinate thereof into data of DICOM standard format.
